(19) United States
(12) Patent Application Publication
(10) Pub. No.: US 2015/0033515 A1
(43) Pub. Date: Feb. 5, 2015

(54) SNAP HOOK HAVING SAFETY LOCKING MECHANISM

(71) Applicant: Fong-O Lai, Taichung (TW)

(72) Inventor: Fong-O LAI, Taichung (TW)

(73) Assignee: Fong-O Lai, Taichung (TW)

(21) Appl. No.: 13/957,461

(22) Filed: Aug. 2, 2013

(51) Int. Cl. F16B 45/02

(52) U.S. Cl. CPC F16B 45/02
USPC 24/594.1; 24/601.5

(57) ABSTRACT

A snap hook includes a hook member having a space and a gap communicating with each other for forming an attaching end and a receiving end, a pivotal gate having one end pivotally attached to the attaching end of the hook member with a pivot axle and having another end for engaging with the receiving end of the hook member, and a lock device includes a latch member slidably engaged in the pivotal gate and having an engaging element for engaging with the hook member and for anchoring the pivotal gate to the hook member at the locking position, the latch member includes an extension, and a knob attached to the extension for disengaging the engaging element of the latch member from the hook member.

### BACKGROUND OF THE INVENTION

1. Field of the Invention

The present invention relates to a snap hook or S-hook or the like, and more particularly to a snap hook or S-hook including a safety locking member attached to a pivotal gate of the snap hook for solidly locking the C-shaped hook body and for preventing the pivotal safety locking member from being unlocked or opened inadvertently.

2. Description of the Prior Art

Typical snap hooks or coupling mechanisms or S-hooks comprise an elongated body member pivotally attached to a handle or loop and including a hook formation formed or provided on one end for engaging with a cable or other objects, and a latch pivotally attached to the handle or loop for selectively locking the hook formation and thus for stably anchoring or locking or securing the cable or other objects to the elongated body member.

For example, U.S. Pat. No. 4,440,432 to Goris, U.S. Pat. No. 4,539,732 to Wolner, U.S. Pat. No. 5,608,953 to Petzl et al., U.S. Pat. No. 5,791,025 to Maurice et al., U.S. Pat. No. 6,161,264 to Choate, and U.S. Pat. No. 6,588,076 to Choate disclose several of the typical snap hooks or swivel coupling devices each comprising a central elongate body member with a hook member or formation formed or provided on one end and a swivel ring at the other end thereof, and a latch pivotally attached to the body member for selectively locking the hook formation and thus for stably anchoring or locking or securing the cable or other objects to the elongated body member.

Some of the typical snap hooks or swivel coupling devices each further comprise a pivoting finger associated to a locking ring movable in rotation between a first locking position and a second unlocking position, and a locking bolt cooperates with the locking ring to selectively lock the ring positively in the first locking position.

However, the pivotal latch may be easily opened to unlock the hook formation and thus for allowing the cable or other objects to be easily disengaged from the elongated body member inadvertently. The locking ring is normally rotatable relative to the pivoting finger and may not be used to solidly engage with a C-shaped metallic body and to solidly lock the typical snap hooks or swivel coupling devices in place.

The present invention has arisen to mitigate and/or obviate the afore-described disadvantages of the conventional snap hooks or coupling devices.

### SUMMARY OF THE INVENTION

The primary objective of the present invention is to provide a snap hook including a safety locking member attached to a pivotal gate and movable to engage with one end of a C-shaped hook body for solidly securing or locking the C-shaped hook body and for preventing the pivotal safety locking member from being unlocked or opened inadvertently.

In accordance with one aspect of the invention, there is provided a snap hook comprising a hook member including a space formed therein, and including a gap formed in the hook member and communicating with the space of the hook member for forming an attaching end and a receiving end, and including an engaging member provided in the attaching end of the hook member, a pivotal gate including a first end portion pivotally attached to the attaching end of the hook member with a pivot axle for allowing the pivotal gate to be pivoted relative to the hook member between a locking position and an unlocking position, and including a second end portion for selectively contacting and engaging with the receiving end of the hook member and for selectively anchoring and positioning the pivotal gate to the hook member at the locking position, and including a compartment formed in the pivotal gate, and including a channel formed in the pivotal gate and communicating with the compartment of the pivotal gate, and a lock device including a latch member slidably engaged in the compartment of the pivotal gate, and including an engaging element extended from the latch member and movable toward and away from the attaching end of the hook member for selectively engaging with the engaging member of the hook member and for selectively anchoring and positioning the pivotal gate to the hook member at the locking position, the latch member including an extension extended therefrom and slidably engaged in the channel of the pivotal gate, and including a knob attached to the extension of the latch member for moving the latch member relative to the hook member and for selectively disengaging the engaging element of the latch member from the engaging member of the hook member, and for thus allowing the pivotal gate to be pivoted or rotated relative to the hook member between the locking position and the unlocking position.

The pivotal gate includes a spring biasing member engaged in the compartment of the pivotal gate and contacted and engaged with the latch member for biasing and forcing the engaging element of the latch member to selectively engage with the engaging member of the hook member.

The latch member includes a stud extended therefrom for engaging with the spring biasing member and for anchoring and retaining or positioning the latch member to the spring biasing member and for allowing the spring biasing member to bias and force the engaging element to selectively engage with the engaging member of the hook member.

The pivotal gate includes a chamber formed in the first end portion of the pivotal gate and formed or defined between two flaps for receiving and engaging with the attaching end of the hook member and for allowing the first end portion of the pivotal gate to be pivotally attached to the attaching end of the hook member with the pivot axle.

A spring biasing member may further be provided and engaged with the pivot axle and includes two legs or end portions contacted and engaged with the hook member and the pivotal gate respectively for biasing and forcing the second end portion of the pivotal gate to engage with the receiving end of the hook member at the first locking position.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a snap hook in accordance with the present invention;

FIG. 2 is a partial exploded view of the snap hook;

FIG. 3 is another plan schematic view similar to FIG. 1, in which a portion of the snap hook has been cut off for showing the inner structure of the snap hook; and

FIGS. 4, 5 are other plan schematic views similar to FIGS. 1 and 3 illustrating the operation of the snap hook.

### DETAILED DESCRIPTION OF THE PREFERRED EMBODIMENT

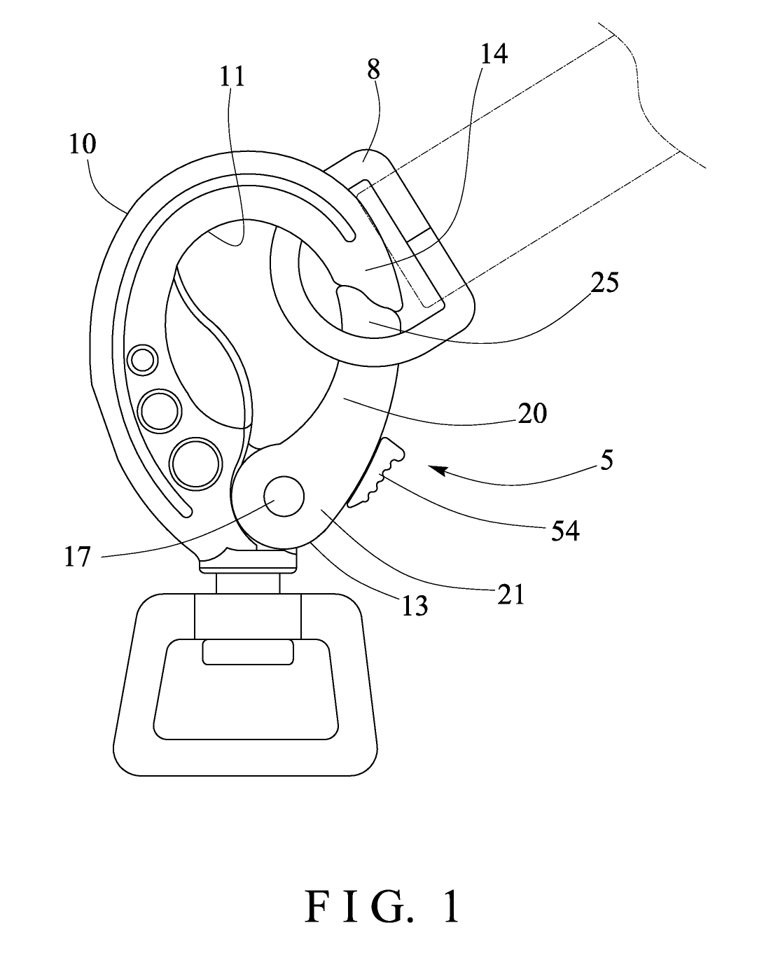

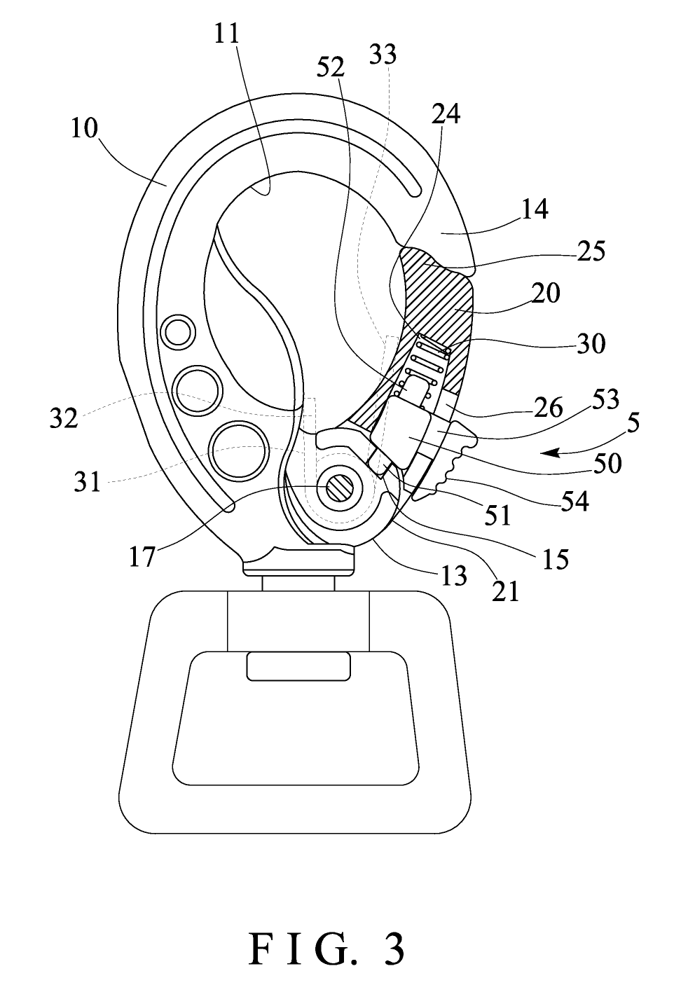

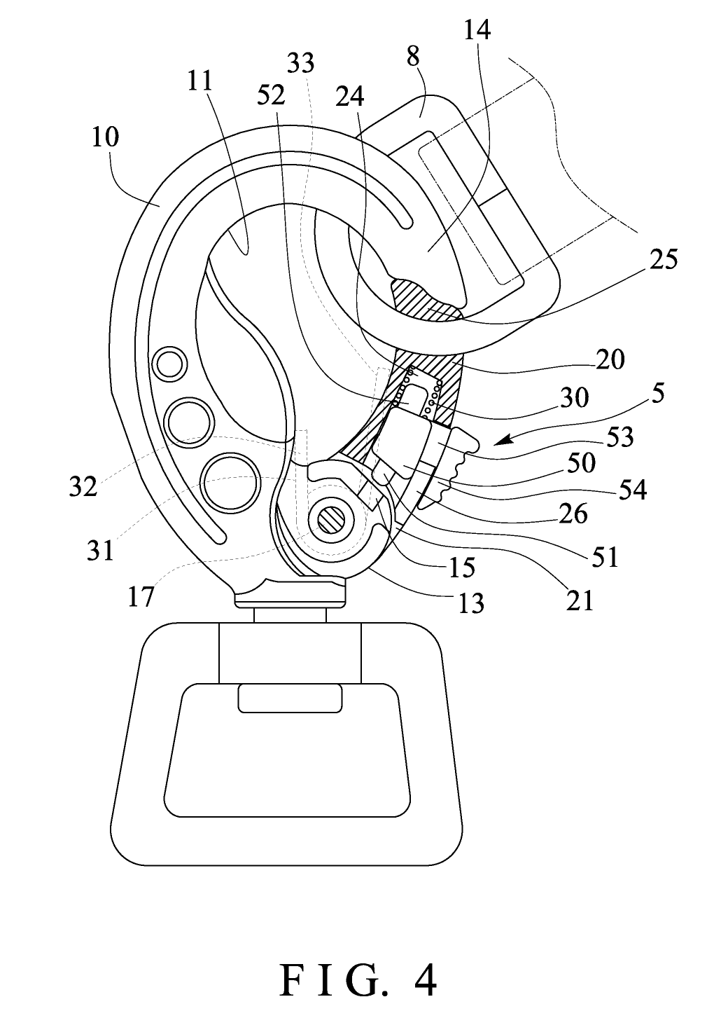

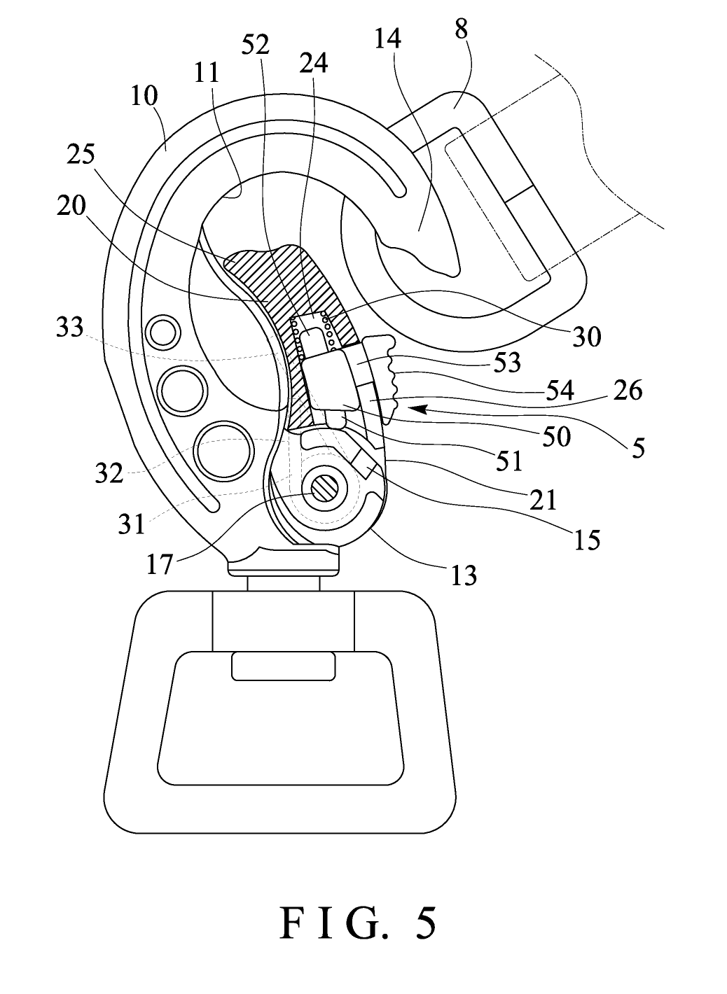

Referring to the drawings, and initially to FIGS. 1-3, a snap hook in accordance with the present invention comprises a substantially C-shaped hook body or member 10 including a space 11 formed therein for receiving one or more cables, rings or loops 8 (FIGS. 4, 5) or other objects, and including a gap 12 formed in the hook member 10 (FIG. 5) and communicating with the space 11 of the hook member 10 for forming or defining two free ends 13, 14 in the hook member 10, such as a first or attaching end 13 and a second or receiving end 14. It is preferable that the C-shaped hook member 10 is bent or formed with an elongated rod element which may include various cross sections, such as circular, square, rectangular or other cross sections, and the hook member 10 includes a cut-off portion or cavity or engaging member 15 formed or provided in one of the free ends 13, such as the first or attaching end 13 (FIGS. 3-5).

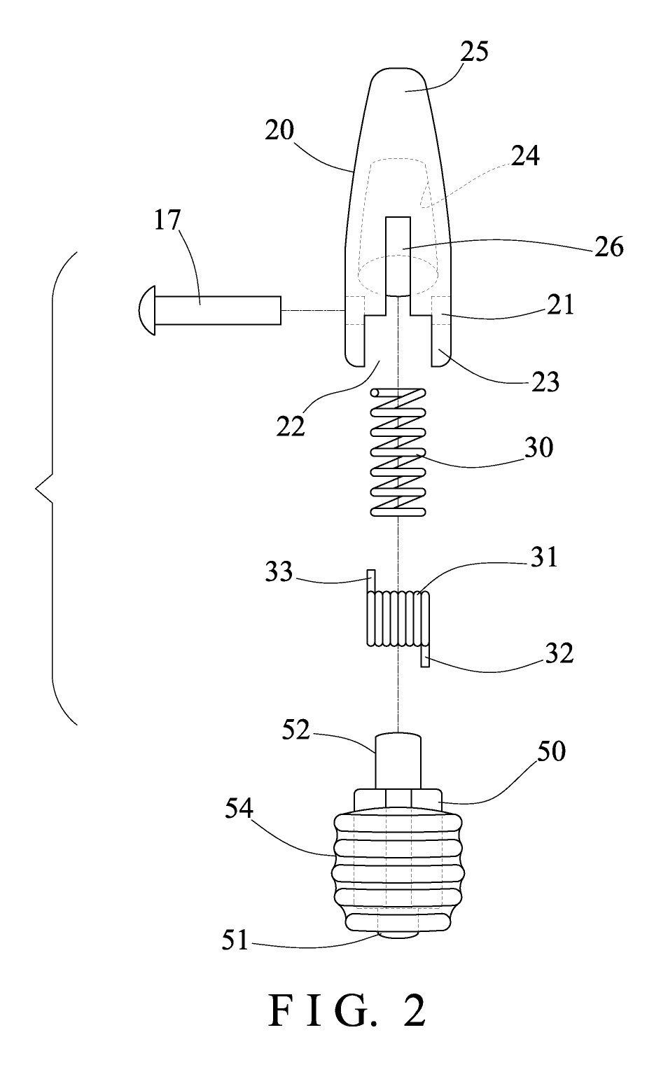

A pivotal member or shank or gate 20 includes one or first end portion 21 pivotally or rotatably attached or mounted or secured or coupled to the attaching end 13 of the hook member 10 with a pivot axle 17 for allowing the pivotal gate 20 to be pivoted or rotated relative to the hook member 10 between a first locking position (FIGS. 1, 3, 4) and a second unlocking position (FIG. 5), for example, the pivotal gate 20 includes a space or chamber 22 formed in the one or first end portion 21 of the pivotal gate 20 (FIG. 2) and formed or defined between two flaps 23 for receiving or engaging with the attaching end 13 of the hook member 10, and includes a chamber or space or compartment 24 formed therein and communicating with the chamber 22 of the pivotal gate 20 for receiving or engaging with a spring biasing member 30.

The pivotal gate 20 includes another or second end portion 25 for selectively contacting or engaging with the receiving end 14 of the hook member 10 and for selectively anchoring or retaining or positioning the pivotal gate 20 to the hook member 10 at the first locking position (FIGS. 1, 3, 4). Another or second spring biasing member 31 is attached or mounted or secured or engaged onto the attaching end 13 of the hook member 10, the one or first end portion 21 of the pivotal gate 20, or the pivot axle 17 and contacted or engaged between the hook member 10 and the pivotal gate 20, for example, the spring biasing member 31 includes one or first end portion 32 contacted or engaged with the hook member 10, and another or second end portion 33 contacted or engaged with the pivotal gate 20 for biasing and forcing or moving the second end portion 25 of the pivotal gate 20 to selectively contact or engage with the receiving end 14 of the hook member 10 at the first locking position (FIGS. 1, 3, 4).

A latch or lock device 5 includes a lock or catch or latch member 50 slidably received or engaged in the compartment 24 of the pivotal gate 20 and slidable or movable along the compartment 24 of the pivotal gate 20 and to be moved toward or away from the attaching end 13 of the hook member 10, and the latch member 50 includes a projection or protrusion or tongue or engaging element 51 provided or extended therefrom for selectively engaging with the cavity or engaging member 15 that is formed in the first or attaching end 13 of the hook member 10 (FIG. 3) for selectively anchoring or retaining or positioning or latching or locking the pivotal gate 20 to the hook member 10 at the first locking position (FIG. 3). The latch member 50 is contacted or engaged with the spring biasing member 30, and further includes another tongue or projection or protrusion or peg or stud 52 extended therefrom for selectively engaging with the spring biasing member 30 and for anchoring or retaining or positioning the latch member 50 to the spring biasing member 30 and thus for allowing the spring biasing member 30 to suitably bias and force or move the tongue or engaging element 51 to selectively engage with the cavity or engaging member 15 of the first or attaching end 13 of the hook member 10.

The pivotal gate 20 further includes a slot or groove or channel 26 formed in the pivotal gate 20 and communicating with the compartment 24 of the pivotal gate 20, and the latch member 50 includes a protrusion or peg or stud or projection or extension 53 extended therefrom and slidably received or engaged in the channel 26 of the pivotal gate 20, and further includes a handle or push button or knob 54 attached or mounted or secured or formed integral with the extension 53 or the latch member 50 for moving the latch member 50 against or onto the spring biasing member 30 and thus for selectively moving or disengaging the tongue or engaging element 51 of the latch member 50 from the cavity or engaging member 15 of the first or attaching end 13 of the hook member 10, and thus for allowing the pivotal gate 20 to be suitably and selectively pivoted or rotated relative to the hook member 10 between the first locking position (FIGS. 1, 3, 4) and the second unlocking position (FIG. 5).

In operation, as shown in FIG. 5, when the pivotal gate 20 is pivoted or rotated relative to the hook member 10 and into the space 11 of the hook member 10, the gap 12 and/or the space 11 of the hook member 10 may be opened for allowing the cable, ring or loop 8 or other objects to be selectively engaged into or disengaged from the hook member 10. When the pivotal gate 20 is released, the spring biasing member 31 may selectively bias and force or move the second end portion 25 of the pivotal gate 20 to selectively contact or engage with the receiving end 14 of the hook member 10 at the first locking position (FIGS. 1, 3, 4). The tongue or engaging element 51 of the latch member 50 may then be biased and forced or pushed or urged or moved to selectively engage with the cavity or engaging member 15 of the first or attaching end 13 of the hook member 10 by the spring biasing member 30 in order to suitably and selectively anchor or retain or position or secure or latch or lock the pivotal gate 20 to the hook member 10 at the first locking position (FIG. 3).

At this moment, the cable, ring or loop 8 that is hooked or engaged with the hook member 10 will not be easily contacted or engaged with the push button or knob 54 of the latch member 50 and thus will not move the latch member 50 relative to the pivotal gate 20 and the hook member 10, and thus will not move and disengage the tongue or engaging element 51 of the latch member 50 from the cavity or engaging member 15 of the first or attaching end 13 of the hook member 10, such that the pivotal gate 20 will have no chance to be pivoted or rotated relative to the hook member 10 from the first locking position to the second unlocking position, and such that the cable, ring or loop 8 will not be moved and disengaged from the hook member 10 inadvertently.

Accordingly, the snap hook in accordance with the present invention includes a safety locking member attached to a pivotal gate of the snap hook for solidly locking the C-shaped hook body and for preventing the pivotal safety locking member from being unlocked or opened inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A snap hook comprising:
a hook member including a space formed therein, and including a gap formed in said hook member and communicating with said space of said hook member for forming an attaching end and a receiving end, and including an engaging member provided in said attaching end of said hook member,
a pivotal gate including a first end portion pivotally attached to said attaching end of said hook member with a pivot axle for allowing said pivotal gate to be pivoted relative to said hook member between a locking position and an unlocking position, and including a second end portion for selectively contacting and engaging with said receiving end of said hook member and for selectively anchoring and positioning said pivotal gate to said hook member at said locking position, and including a compartment formed in said pivotal gate, and including a channel formed in said pivotal gate and communicating with said compartment of said pivotal gate, and
a lock device including a latch member slidably engaged in said compartment of said pivotal gate, and including an engaging element extended from said latch member and movable toward and away from said attaching end of said hook member for selectively engaging with said engaging member of said hook member and for selectively anchoring and positioning said pivotal gate to said hook member at said locking position, said latch member including an extension extended therefrom and slidably engaged in said channel of said pivotal gate, and including a knob attached to said extension of said latch member for moving said latch member relative to said hook member and for selectively disengaging said engaging element of said latch member from said engaging member of said hook member, and for allowing said pivotal gate to be pivoted relative to said hook member between said locking position and said unlocking position.

2. The snap hook as claimed in claim 1, wherein said pivotal gate includes a spring biasing member engaged in said compartment of said pivotal gate and contacted and engaged with said latch member for biasing and forcing said engaging element of said latch member to selectively engage with said engaging member of said hook member.

3. The snap hook as claimed in claim 2, wherein said latch member includes a stud extended therefrom for engaging with said spring biasing member and for anchoring said latch member to said spring biasing member and for allowing said spring biasing member to bias and force said engaging element to selectively engage with said engaging member of said hook member.

4. The snap hook as claimed in claim 1, wherein said pivotal gate includes a chamber formed in said first end portion of said pivotal gate and defined between two flaps for receiving and engaging with said attaching end of said hook member.

5. The snap hook as claimed in claim 1 further comprising a spring biasing member engaged with said pivot axle and engaged with said hook member and said pivotal gate for biasing said second end portion of said pivotal gate to engage with said receiving end of said hook member at said first locking position.
